(19) United States
(12) Patent Application Publication
(10) Pub. No.: US 2024/0150041 A1
(43) Pub. Date: May 9, 2024

(54) ACTIVE DEBRIS REMOVAL SPACE SAFETY AND SUSTAINABILITY SYSTEM

(71) Applicant: Robert P. Theodorson, Arlington, VA (US)

(72) Inventor: Robert P. Theodorson, Arlington, VA (US)

(21) Appl. No.: 17/981,534

(22) Filed: Nov. 7, 2022

(51) Int. Cl. B64G 1/10; B64G 1/40; B64G 1/44; B64G 1/52

(52) U.S. Cl. CPC B64G 1/1078; B64G 1/40; B64G 1/44; B64G 1/52

(57) ABSTRACT

A satellite for clearing debris from congested orbital paths includes an elongated body with first and second longitudinal ends that contain magnets in a bastion shape that attract metallic space debris in an indirect collection manner. The bastions are by design protected from collision damage from incoming debris that the satellite system collects during active debris removal missions. The elongated body defines a transverse direction generally perpendicular to a longitudinal direction. The elongated body further includes an exterior and defines an interior capsule. The satellite also includes a first magnet coupled to the first longitudinal end of the elongated body. One or both poles of the first magnet are oriented such that a first field is emitted from the first longitudinal end substantially along the longitudinal direction. The satellite additionally includes a power system having a battery and positioned within or partially within the interior capsule. The battery is recharged by a system of retractable, and therefore protectable, solar panels. A propulsion system of the satellite includes two or more boosters coupled to the exterior of the elongate body on both ends. The boosters are configured to orient the first longitudinal end such that the first field attracts a magnetic item of space debris. The boosters are used to lower the active debris removal satellite and use momentum to deorbit space debris. Likewise, the boosters are used to reachieve orbit or move away from Earth once the debris has been successfully deorbited, thus making the satellite system reusable for the satellite operator's next mission of choice.

### FIELD

The present invention relates to systems associated with satellites and, more particularly, to a satellite for clearing or reducing debris from a congested orbital path or targeted point.

### BACKGROUND

The congestion among certain earth orbits has grown steadily since human space exploration and cultivation began. While the probability of a collision with orbital debris is often low, the inherent velocities required for orbital mechanics may lead to catastrophic results. Attempts to reduce the chances of collision with orbital obstacles include avoidance, good space traffic coordination as well as space situational awareness, and orbital rendezvous and removal, to name a few. However, the ever-increasing amount of space debris makes avoidance increasingly difficult, thus reducing the safety and sustainability of space for all spacefaring nations and commercial operators. While space system may be able to manually adjust their position in anticipation of greater than supersonic speed collisions, such precautions are costly and finite, and are not guaranteed to ensure the operation or even survival of the space system. Should a collision occur, the impact of two objects will create hundreds or thousands of new pieces of space debris. While attempts to intercept the orbit of debris has been attempted, the success has been limited due to the complicated determination and execution of the required orbital mechanics. When successful, the cost of removing an intercepted item of space debris may be prohibitively expensive. The reusable design of this active debris removal satellite ensures that operators can conduct several missions, thus lowering costs to customers. Using magnets to capture space debris, and boosters to aim the satellite and attached debris towards Earth, the satellite is able to use momentum to push the debris down towards Earth, simulating a natural deorbit. Attached boosters allow the satellite to move towards, or further away from Earth depending on where in the mission the satellite currently is.

In view of the circumstances described above, there is a need for new, better, and cheaper methods of active debris removal that do not rely on precise proximity and rendezvous operations which are cost prohibitive and still quite experimental.

### BRIEF SUMMARY

Embodiments of the present disclosure address the above needs and/or achieve other advantages by providing systems, apparatuses, and methods related to a satellite for clearing or removing debris from an orbital path or point in space via magnetic interception of the debris. For example, one or more magnets may be coupled to the respective ends of the satellite in order to attract items within an operable range of the respective magnet. Thus, the satellite may attract debris on one or more ends and the positions that the satellite is best able to withstand the impact of the collision with such items.

In certain aspects, the present disclosure is directed to a satellite for clearing debris from congested orbital paths or specific points the operator chooses for the satellite's mission. The satellite includes an elongate body with a first longitudinal end and a second longitudinal end. The elongate body defines a transverse direction generally perpendicular to a longitudinal direction. The elongate body further includes an exterior and defines an interior satellite bus. The satellite also includes a first magnet coupled to the first longitudinal end of the elongate body. One or both poles of the first magnet are oriented such that a first field is emitted from the first longitudinal end substantially along the longitudinal direction. The satellite additionally includes a power system having a battery and positioned within or partially within the interior satellite bus. A propulsion system of the satellite includes two or more boosters coupled to the exterior of the elongate body. The boosters are configured to orient the first longitudinal end such that the first field attracts a magnetic item of space debris.

In at least one embodiment, the first magnet may define an exterior bastion shape. In an additional or alternative embodiment, the satellite may further include a second magnet coupled to the second longitudinal end of the elongate body. One or both poles of the second magnet may be oriented such that a second field is emitted from the second end substantially along the longitudinal direction. In an additional or alternative embodiment, the satellite may further include a solenoid operably coupled with the first magnet and a battery of the power system. In an additional or alternative embodiment, the satellite may further include a controller communicatively coupled to the solenoid and configured such that a magnetic intensity of the first magnetic field may be adjusted.

In an additional or alternative embodiment, the power system may include a first solar panel configured to selectively extend from the elongate body along the transverse direction or to retract within the elongate body along the transverse direction. In an additional or alternative embodiment, the power system may include a track and a first solar panel assembly. The first solar panel assembly may include the first solar panel and a second solar panel. In some embodiments, each of the first and second solar panels may be coupled to the track. In an additional or alternative embodiment, the track of the first solar panel assembly may be configured to, selectively, extend from the elongate body along the transverse direction or to retract within the elongate body along the transverse direction. In an additional or alternative embodiment, the first solar panel and the second solar panel may be rotatably coupled to the track such that each of the first solar panel and the second solar panel may be selectively rotated about the longitudinal direction. In an additional or alternative embodiment, the power system may include a second track and a second solar panel assembly. In some embodiments, the second solar panel assembly may include a third solar panel and a fourth solar panel. Furthermore, each of the third solar panel and the fourth solar panel may be coupled to the second track.

In an additional or alternative embodiment, the power system may include a plurality of solar panels fixed to the exterior of the elongate body. In an additional or alternative embodiment, the power system may include a protective shield for each solar panel of the plurality of solar panels.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE SEVERAL VIEWS OF THE DRAWINGS

These and other features, aspects and advantages of the present invention are better understood when the following detailed description of the invention is read with reference to the accompanying drawings, in which:

FIG. 1 illustrates a top perspective view of an embodiments of a satellite for removing space debris, according to an exemplary aspect of the present disclosure;

FIG. 2 illustrates another top perspective view of an embodiment of the satellite for removing space debris with extended solar panels, in accordance with exemplary aspects of the present disclosure;

FIG. 3 illustrates another top perspective view of an embodiment of the satellite for removing space debris with extended and rotated solar panels, in accordance with exemplary aspects of the present disclosure;

FIG. 4 illustrates another top perspective view of an embodiment of the satellite for removing space debris including first and second magnets coupled to respective ends of the satellite, in accordance with exemplary aspects of the present disclosure;

FIG. 5 illustrates another top perspective view of an embodiment of the satellite for removing space debris including the first and second magnets with extended solar panels, in accordance with exemplary aspects of the present disclosure;

FIG. 6 illustrates another top perspective view of an embodiment of the satellite for removing space debris including the first and second magnets and with extended and rotated solar panels, in accordance with exemplary aspects of the present disclosure;

FIG. 7 illustrates a side view of an embodiment of the satellite for removing space debris with partially extended solar panels, in accordance with exemplary aspects of the present disclosure;

FIG. 8 illustrates a side view of an embodiment of the satellite for removing space debris with retracted solar panels, in accordance with exemplary aspects of the present disclosure;

FIG. 9 illustrates a cross-section view of the embodiments of the satellite for removing space debris along section line A-A of FIG. 8, in accordance with exemplary aspects of the present disclosure;

FIG. 10 illustrates another side view of an embodiment of the satellite for removing space debris with a retracted solar panel, in accordance with exemplary aspects of the present disclosure;

FIG. 11 illustrates a side view of an embodiment of the satellite for removing space debris with extended and rotated solar panels, in accordance with exemplary aspects of the present disclosure;

FIG. 12 illustrates another side view of an embodiment of the satellite for removing space debris with a retracted solar panel, in accordance with exemplary aspects of the present disclosure;

FIG. 13 illustrates a cross-section view of the embodiments of the satellite for removing space debris taken along section line C-C of FIG. 12 and with a retracted solar panel, in accordance with exemplary aspects of the present disclosure;

FIG. 14 illustrates another side view of an embodiment of the satellite for removing space debris with a retracted solar panel, in accordance with exemplary aspects of the present disclosure;

FIG. 15 illustrates a cross-section view of the embodiments of the satellite for removing space debris taken along section line E-E of FIG. 12 and with an extended solar panel, in accordance with exemplary aspects of the present disclosure;

FIG. 16 illustrates another top perspective view of an embodiment of the satellite for removing space debris with extended and rotated solar panels and including a propulsion system, in accordance with exemplary aspects of the present disclosure;

FIG. 17 illustrates a side view of an embodiment of the satellite for removing space debris with extended and rotated solar panels and including the propulsion system, in accordance with exemplary aspects of the present disclosure;

FIG. 18 illustrates a perspective view of an embodiment of a magnet suitable to couple to an end of the satellite for removing space debris, in accordance with exemplary aspects of the present disclosure;

FIG. 19 illustrates a top view of an embodiment of a magnet suitable to couple to an end of the satellite for removing space debris, in accordance with exemplary aspects of the present disclosure;

FIG. 20 illustrates a perspective view of an embodiment of the magnet coupled to an end of the satellite for removing space debris, in accordance with exemplary aspects of the present disclosure;

FIG. 21 illustrates a top view of an embodiment of the magnet coupled to the end of the satellite for removing space debris with extended solar panels, in accordance with exemplary aspects of the present disclosure;

FIG. 22 illustrates another top view of an embodiment of the magnet coupled to the end of the satellite for removing space debris with extended and rotated solar panels, in accordance with exemplary aspects of the present disclosure; and

FIG. 23 illustrates another top view of an embodiment of the magnet coupled to the end of the satellite for removing space debris with extended and rotated solar panels including the propulsion system, in accordance with exemplary aspects of the present disclosure.

Like reference numerals in the drawings may represent and refer to the same, analogous, or similar elements, features, or functions.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling, and operatively coupling; and (ii) indirect connecting coupling, fixing, attaching, communicatively coupling, and operatively coupling via one or more intermediate components or features, unless otherwise specified herein. “Communicatively coupled to” and “operatively coupled to” can refer to physically and/or electrically related components.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

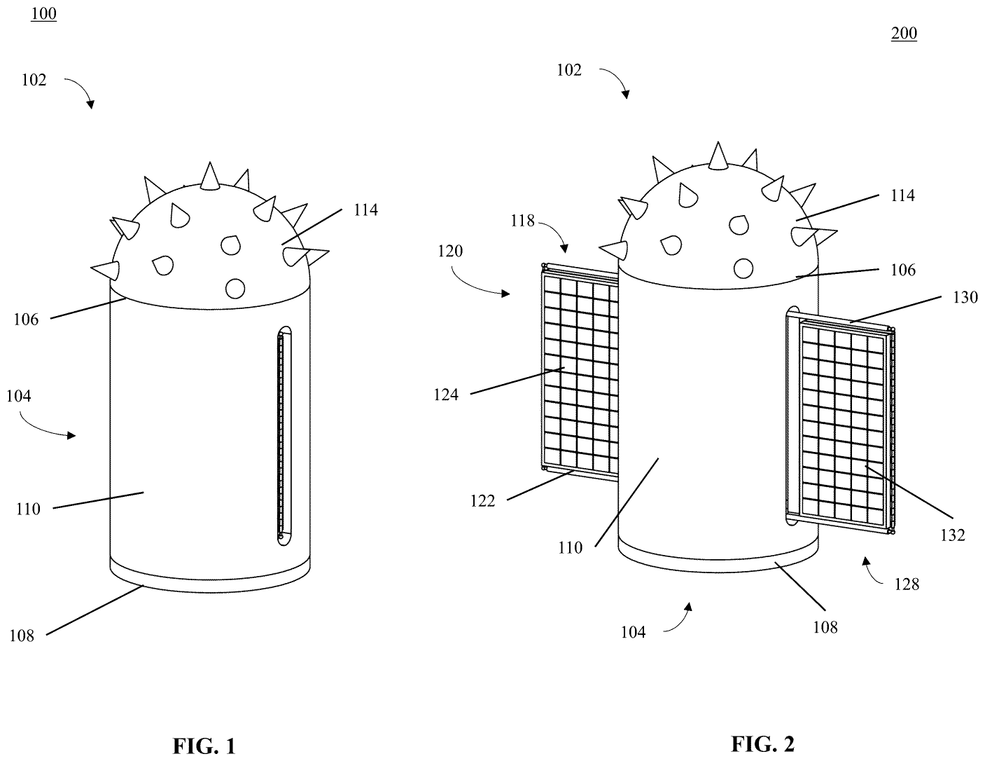

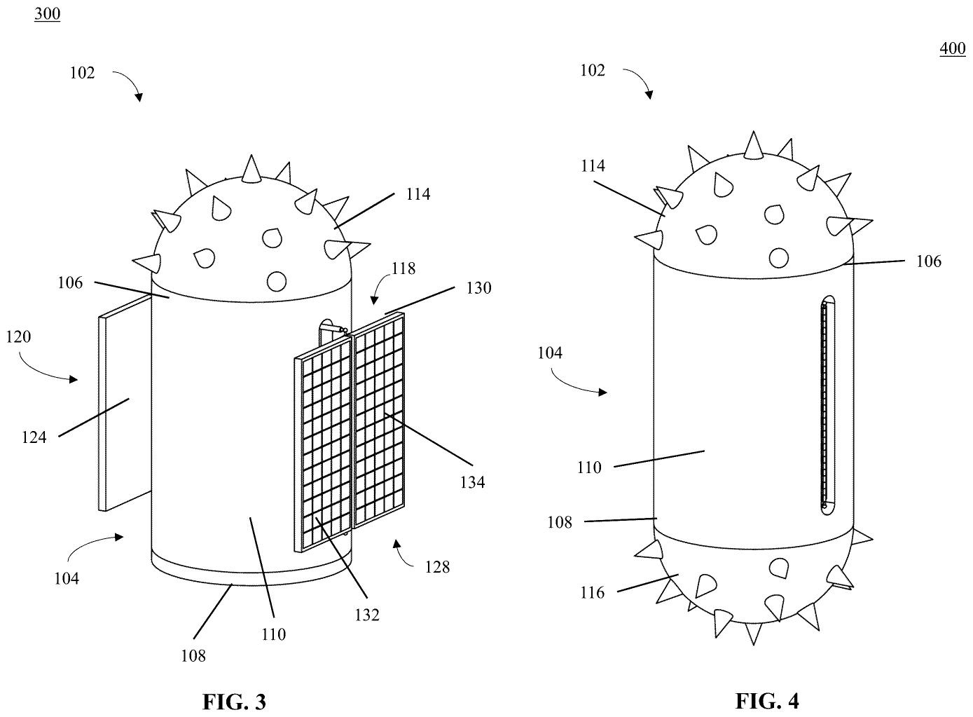

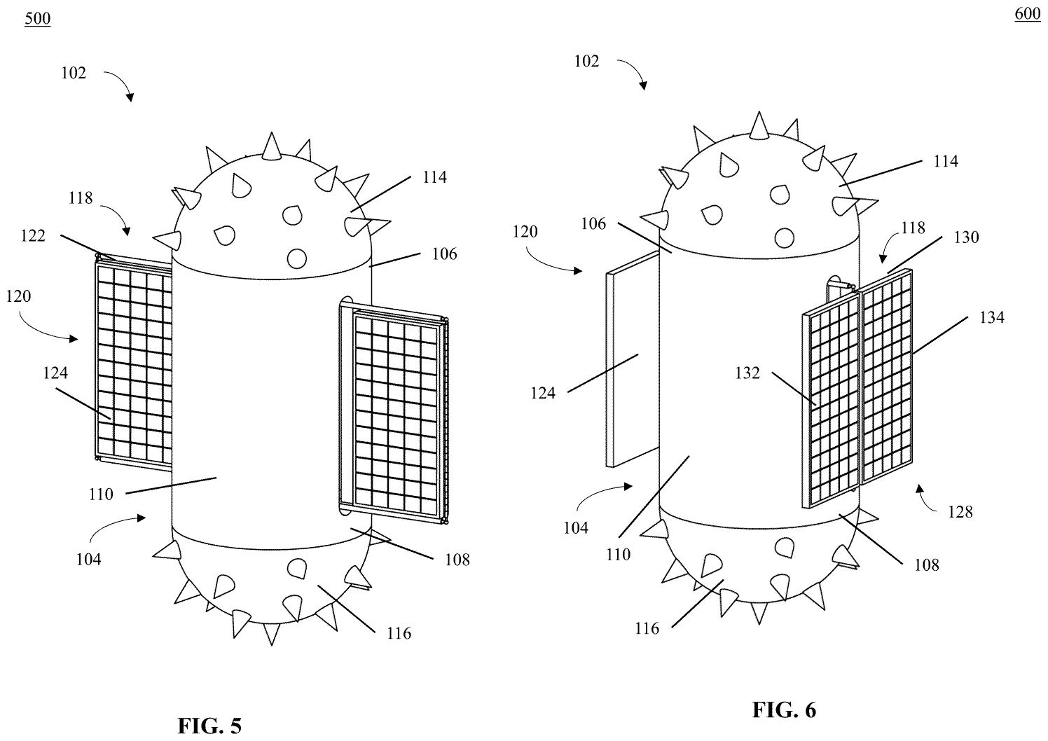

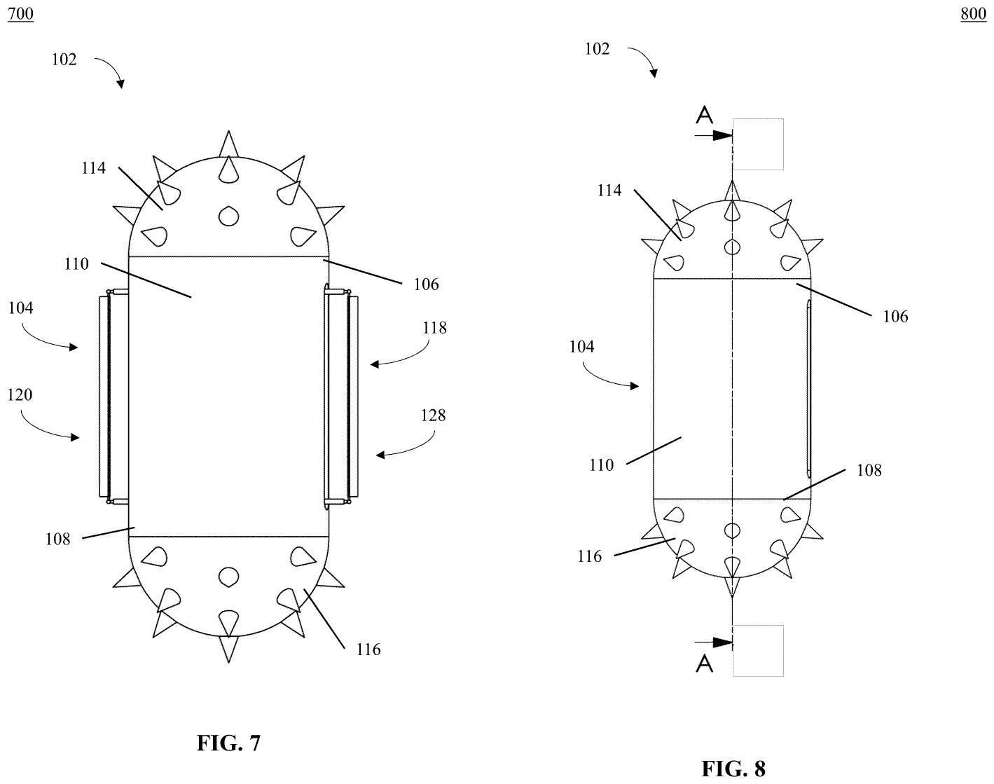

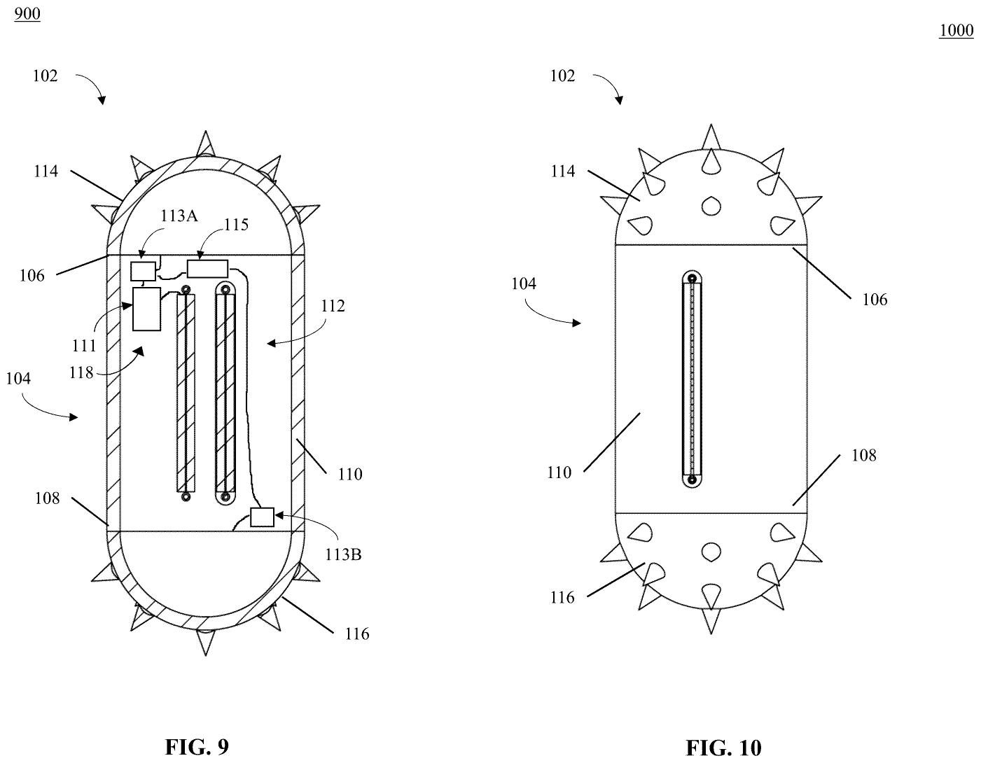

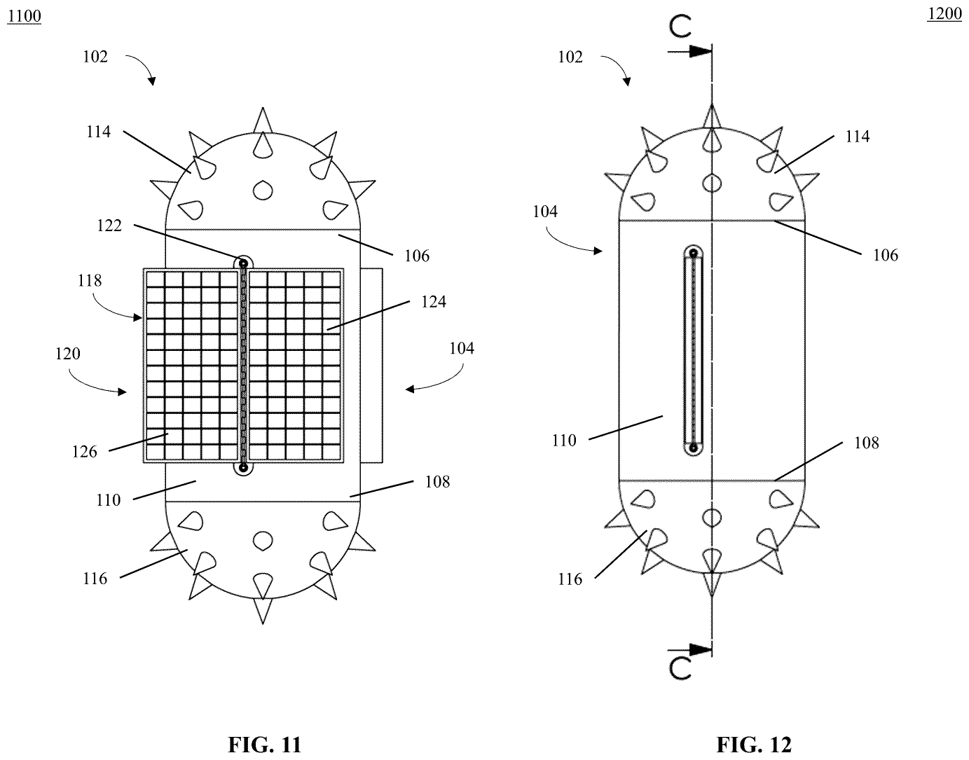

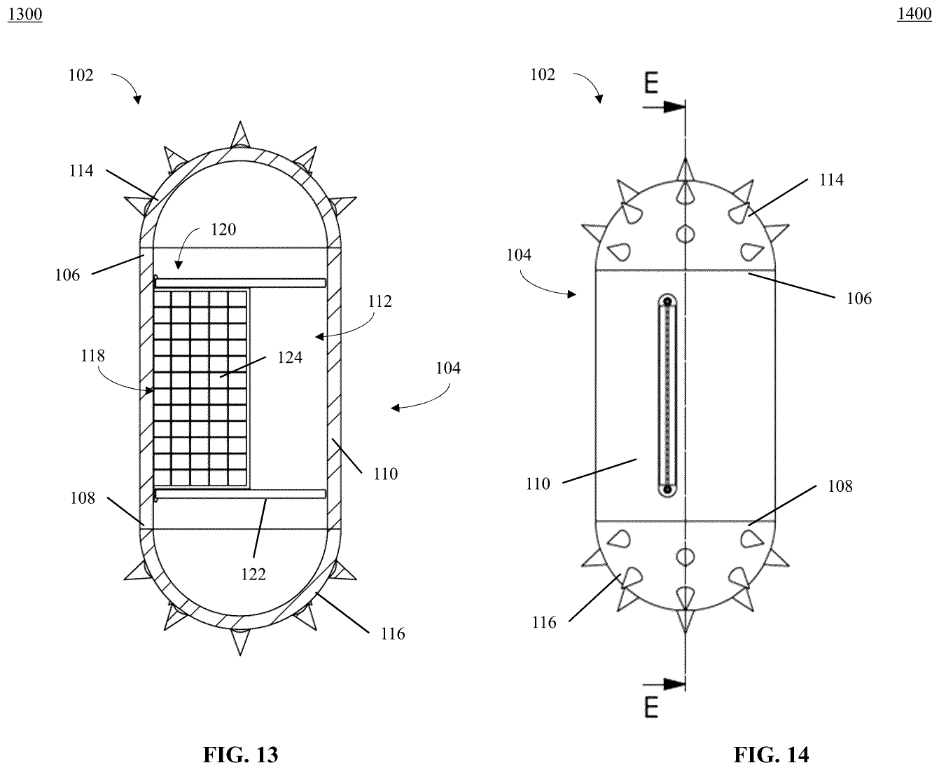

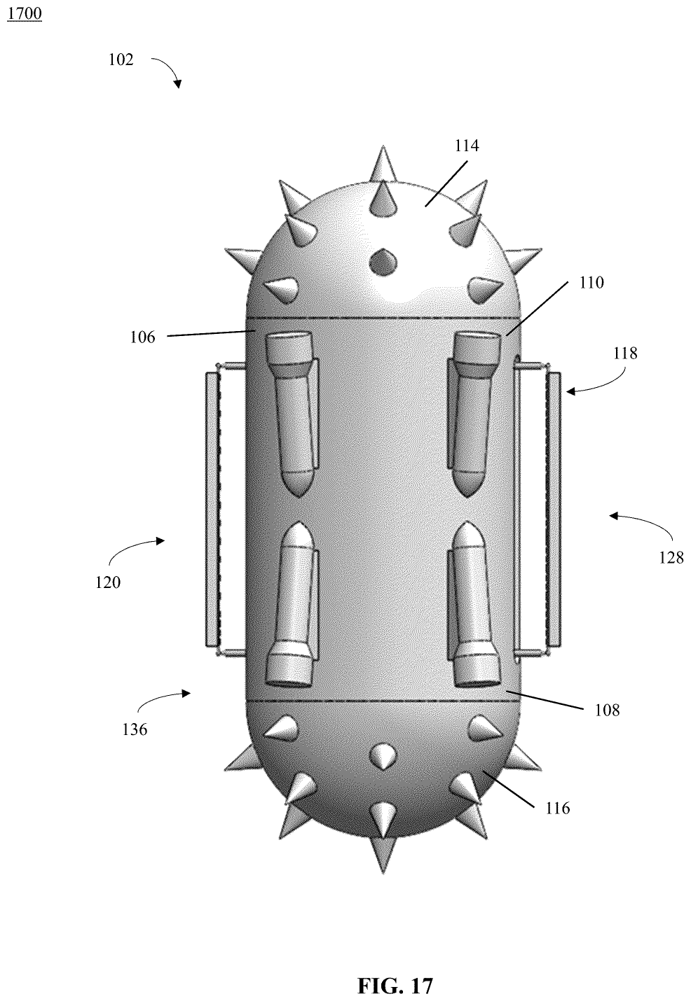

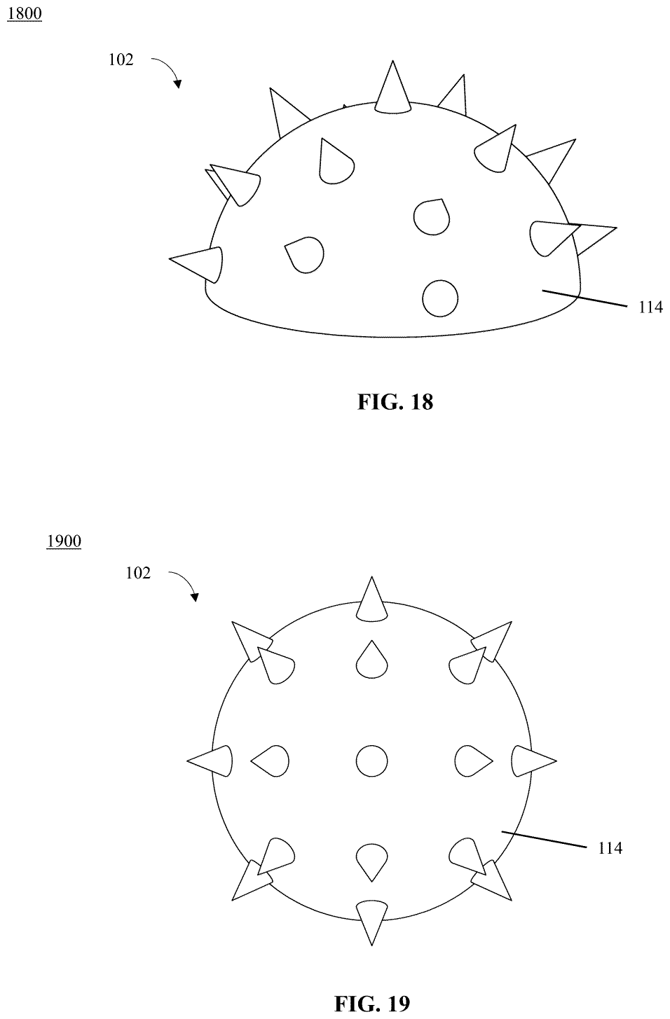

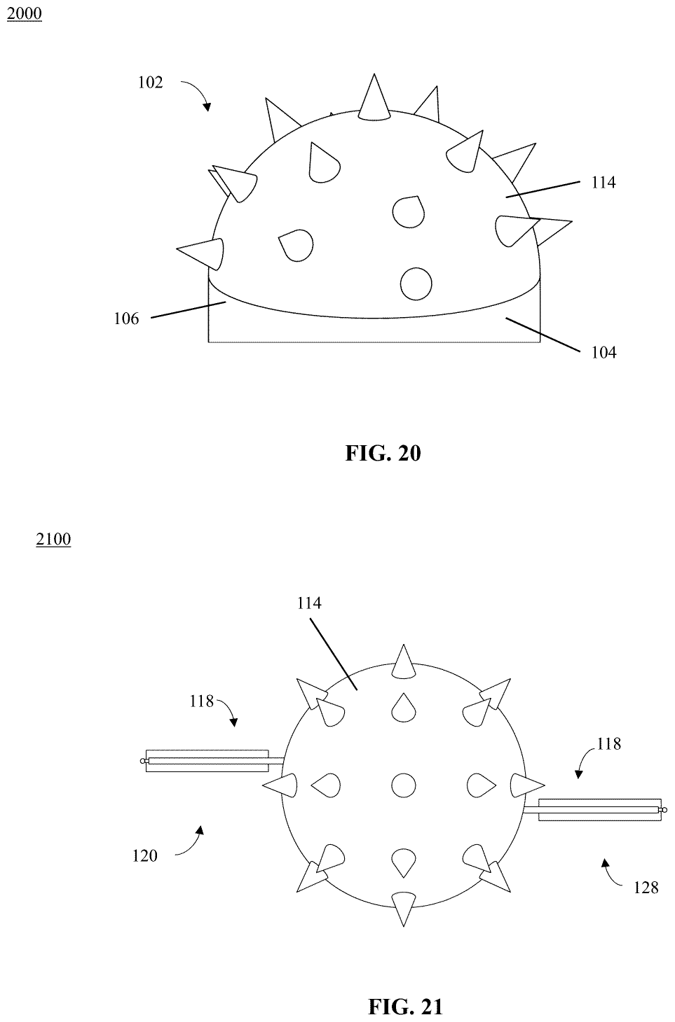

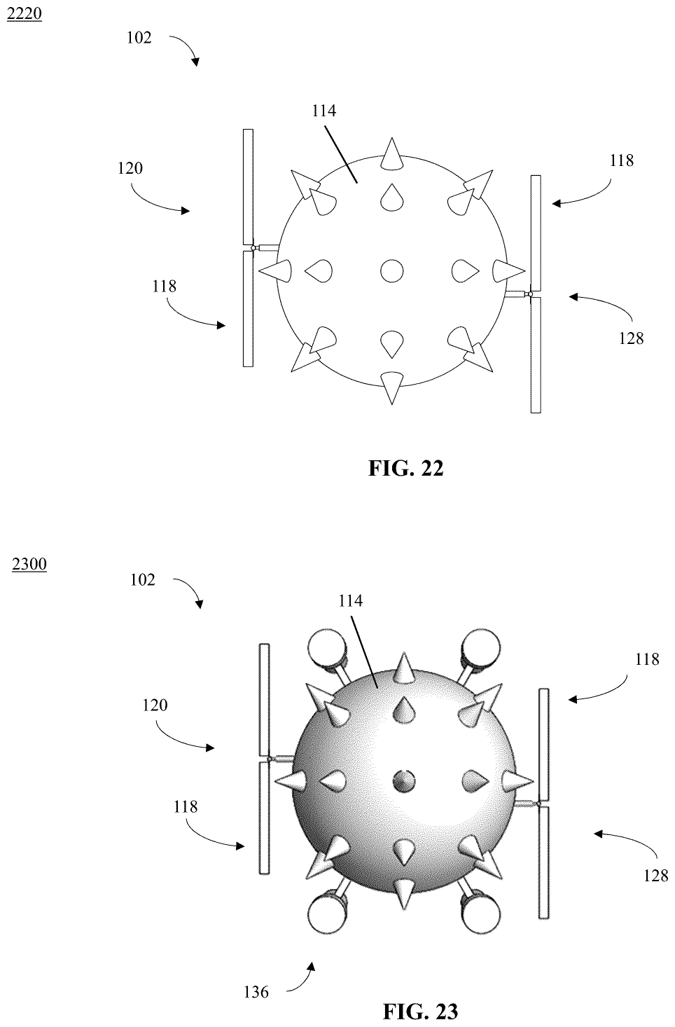

Referring generally to FIGS. 1-23, embodiments of a satellite 102 suitable for clearing debris from congested orbital paths are depicted in accordance with aspects of the present disclosure. The satellite 102 generally includes an elongate body 104 with a first longitudinal end (e.g., first end 106) and a second longitudinal end (e.g., second end 108). One or more magnets may be coupled to the respective ends 106, 108 of the satellite 102 in order to attract items within an operable range of the magnet. For example, items of debris in space may have magnetic potential or may already be magnetically charged The magnet(s) at the ends 106, 108 may attract debris to the satellite 102 at the position that the satellite 102 is best able to withstand the impact of the collision with such items.

The elongated body 104 of the satellite 102 may define a transverse direction generally perpendicular to a longitudinal direction extending between the ends 106, 108. In various embodiments, the elongate body 104 may further include an exterior 110 and define an interior capsule 112. The exterior 110 of the elongated body 104 may be configured to withstand the harsh environment of space and/or low earth orbit. Additionally or alternatively, the exterior 110 may partially or fully enclose, shield, etc. the interior capsule 112 from conditions outside of the exterior 110.

In exemplary aspects of the present disclosure, the satellite 102 may include a first magnet 114 coupled to the first end 106 of the elongate body 104. One or both poles of the first magnet 114 may be oriented such that a field is emitted from the first end 106 substantially along the longitudinal direction. Thus, objects attracted to the first magnet are directed to approach from generally the longitudinal direction and at the first end 106 and first magnet 114, where the satellite 102 is reinforced to withstand such impact. In several embodiments, the satellite 102 may further include a second magnet 116 coupled to the second end 108 of the elongate body 104. One or both poles of the second magnet 116 may be oriented such that a second field is emitted from the second end 108 substantially along the longitudinal direction.

In some embodiments and as shown, the first magnet 114, the second magnet 116, or both may define an exterior bastion shape. Additional or alternative embodiments of the satellite 10 may include a solenoid operably coupled with the first magnet 114 and a battery of a power system 118. Furthermore, the satellite 102 may include a controller communicatively coupled to the solenoid and configured such that a magnetic intensity of the first magnetic field may be adjusted. In some embodiments, the second magnet 116 may be associated with a second solenoid communicatively coupled to the controller and allowing for adjustment of the magnetic intensity of the second magnetic field.

A suitable power system 118 for the satellite 102 may be at least partially positioned within the interior capsule 112 and may include a battery. For example, a battery may be housed within the interior capsule 112. In some embodiments, the power system 118 may include a first solar panel assembly 120 having a first track 122. The first solar panel assembly 120 may include a first solar panel 124 and/or a second solar panel 126. In various configurations the first solar panel 124 may selectively extend from the elongate body 104 along the transverse direction to recharge the battery. The first solar panel 124 may also retract within the elongate body 104 along the transverse direction, such as when the battery is charged, during propulsion activities, or when the exterior environment will likely damage the first solar panel 124. For example, and in some exemplary embodiments, the first solar panel and/or the second solar panel 126 may be coupled to the first track 122. In some embodiments of the satellite 102, the first track 122 of the first solar panel assembly 120 may selectively extend from the elongate body 104 along the transverse direction. Similarly, the first track 122 may selectively retract within the elongate body 104 along the transverse direction. In some embodiments, the first solar panel 124 and the second solar panel 126 may be rotatably coupled to the first track 122. For example, one or both of the first solar panel 124 or the second solar panel 126 may be selectively rotated about the longitudinal direction.

In some embodiments and as shown in the exemplary satellite of FIG. 2, the power system 118 may include a second solar panel assembly 128 and a second track 130. The second solar panel assembly 128 may be configured the same or similar to the first solar panel assembly 120. For instance, the second solar panel assembly 128 may include a third solar panel 132 and a fourth solar panel 134. Furthermore, each of the third solar panel 132 and the fourth solar panel 134 may be coupled to the second track 130. The second solar panel assembly 128, the second track 130, the third solar panel 132 and/or the fourth solar panel 134 may extend out of or retract within the elongate body 104, as described herein. Furthermore, the third solar panel 132, the fourth solar panel 134, or both may be rotatably coupled to the first track 122 to allow for selectively rotation about the longitudinal direction.

While a power system 118 including actuatable solar panels is illustrated in FIGS. 1-23, it should be appreciated that the present disclosure is equally applicable to a satellite 102 including embodiments of the power system 118 having two or more solar panels fixed to the exterior 110 of the elongate body 104. Some embodiments of the power system 118 may include a protective shield for each solar panel fixed to the exterior 110 of the elongate body 104.

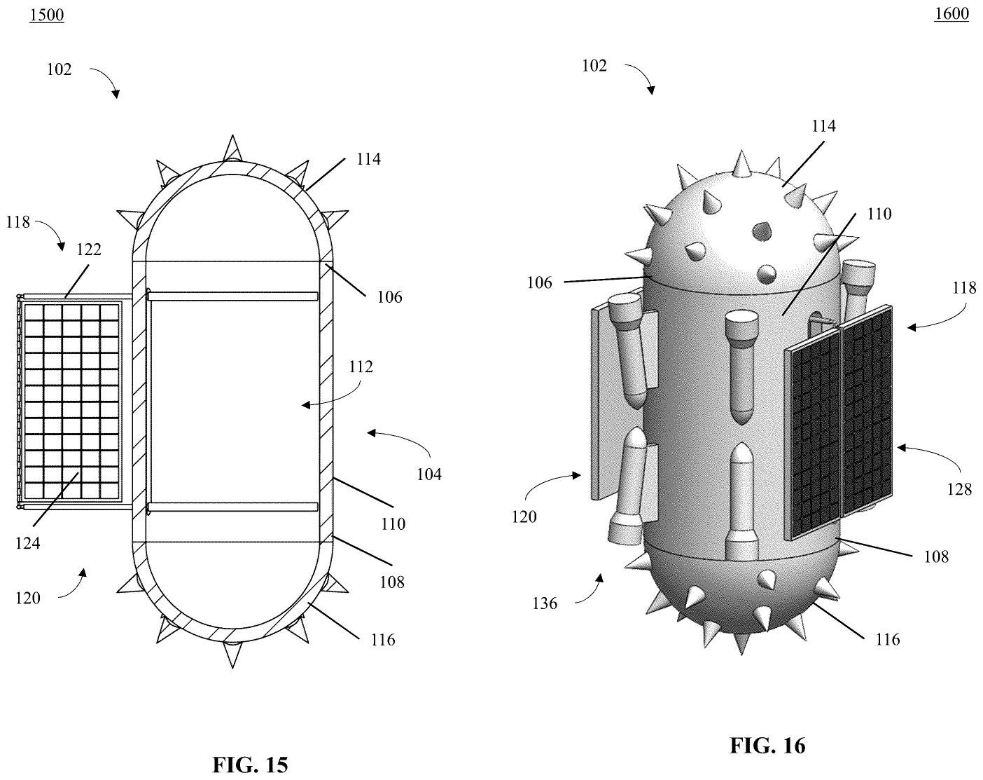

As shown particularly in FIGS. 16 and 23 and in some instances, the satellite 102 may include a propulsion system 136 with two or more boosters coupled to the exterior 110 of the elongate body 104. The boosters am generally suitable to orient the first end 106 such that the first field attracts a magnetic item of space debris. In further or alternative embodiments, the propulsion system 136 and/or the boosters thereof may be suitable to orient the second end 108 such that the second field attracts a magnetic item(s) of space debris. The propulsion system 136 and/or the boosters may also be configured to propel the satellite, such as within an appropriate range to attract a target item in orbit.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims. The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

1. A satellite for clearing debris from congested orbital paths, the satellite comprising:
an elongate body including a first longitudinal end and a second longitudinal end and defining a transverse direction generally perpendicular to a longitudinal direction, the elongate body including an exterior and defining an interior capsule;
a first magnet coupled to the first longitudinal end of the elongate body, at least one pole of the first magnet oriented such that a first field is emitted from the first longitudinal end substantially along the longitudinal direction, wherein the first magnet comprises a semi-circular cap extending from the first longitudinal end, the semi-circular cap including a plurality of cone-shaped projections radially extending outwardly from the semi-circular cap;
a power system positioned, at least in part, within the interior satellite bus and including a battery; and
a propulsion system including a plurality of boosters coupled to the exterior of the elongate body, the plurality of boosters configured to orient the first longitudinal end such that the first field attracts a magnetic item of space debris.

2. (canceled)

3. The satellite of claim 1, further comprising:
a second magnet coupled to the second end of the elongate body, at least one pole of the second magnet oriented such that a second field is emitted from the second end substantially along the longitudinal direction.

4. The satellite of claim 1, further comprising:
a solenoid operably coupled with the first magnet and a battery of the power system.

5. The satellite of claim 4, further comprising:
a controller communicatively coupled to the solenoid and configured such that a magnetic intensity of the first magnetic field may be adjusted.

6. The satellite of claim 1, wherein the power system includes a first solar panel configured to selectively extend from the elongate body along the transverse direction or to retract within the elongate body along the transverse direction.

7. The satellite of claim 6, wherein the power system includes a track and a first solar panel assembly, the first solar panel assembly including the first solar panel and a second solar panel, each of the first solar panel and the second solar panel coupled to the track.

8. The satellite of claim 7, wherein the track of the first solar panel assembly is configured to, selectively, extend from the elongate body along the transverse direction or to retract within the elongate body along the transverse direction.

9. The satellite of claim 7, wherein the first solar panel and the second solar panel are rotatably coupled to the track such that each of the first solar panel and the second solar panel may be selectively rotated about the longitudinal direction.

10. The satellite of claim 7, wherein the power system includes a second track and a second solar panel assembly, the second solar panel assembly including a third solar panel and a fourth solar panel, each of the third solar panel and the fourth solar panel coupled to the second track.

11. (canceled)

12. The satellite of claim 7, wherein the power system includes a protective shield for each solar panel of the first solar panel assembly.
